(19) United States
(12) Patent Application Publication
(10) Pub. No.: US 2012/0294594 A1
(43) Pub. Date: Nov. 22, 2012

(54) AUDIO-VIDEO SYNCHRONIZATION METHOD AND AUDIO-VIDEO SYNCHRONIZATION MODULE FOR PERFORMING AUDIO-VIDEO SYNCHRONIZATION BY REFERRING TO INDICATION INFORMATION INDICATIVE OF MOTION MAGNITUDE OF CURRENT VIDEO FRAME

(76) Inventor: Jer-Min Hsiao, Taipei City (TW)

(21) Appl. No.: 13/109,020

(22) Filed: May 17, 2011

(51) Int. Cl. H04N 5/93

(52) U.S. Cl. 386/353; 386/E05.028

(57) ABSTRACT

An audio-video synchronization method is provided for synchronizing playback of a video bitstream and playback of an audio bitstream. The video bitstream includes a plurality of video frames. The audio-video synchronization method includes: deriving an indication information and a timing information corresponding to a video current frame from the video bitstream, wherein the indication information is indicative of motion magnitude of the current video frame; and referring to the indication information, the timing information and a system clock to deal with the current video frame for synchronizing playback of the video bitstream and playback of the audio bitstream.

### BACKGROUND

The disclosed embodiments relate to an audio-video (AV) processing technique, and more particularly, to an AV synchronization method and AV synchronization module for performing AV synchronization by referring to indication information indicative of motion magnitude of a current video frame.

Conventional multimedia players, e.g., DVD players or computer software, receive and process both audio signal and video signal from an optical disc or a hard disk to play back audio-video (AV) data. When the audio and video signals are asynchronous with each other, the played sound will be leading or lagging the displayed video, subliminally impacting viewer's perception.

Typically, conventional multimedia players provide synchronization mechanism solely based on timing information of the audio and video signals, e.g., the audio and video signals are played synchronously according to a global clock. Alternatively, a play timing of one of the audio and video signals is adjusted in accordance with a play timing of the other of the audio and video signals. For example, when the playback of the video signal is lagging the playback of the audio signal, the conventional multimedia player may choose to drop one or more video frames transmitted via the video bitstream to catch up with the audio signal; on the other hand, when the video signal is leading the audio signal, the conventional multimedia player may choose to repeat a video frame transmitted via the video bitstream for waiting for the audio signal to catch up.

Please refer to FIG. 1, which is a diagram illustrating a conventional AV synchronization method. As shown, the sequential video frames F1-F4 demonstrate a ball falling and then staying still on the ground. Given a synchronization error occurs due to the audio signal leading the video signal, the conventional multimedia player will skip the second video frame F2 and play the video frames F1, F3 and F4 sequentially.

However, in some cases, such synchronization mechanism may bring up some awkward experience to viewers. When the video signal with a fast-motion content is played behind the audio signal, the conventional synchronization mechanism will determine to drop some video frames of the video bitstream to achieve AV synchronization; nevertheless, skipping those video frames containing fast-motion objects may result in an uncoordinated discontinuous viewing perception to viewers. For example, in the case as shown in FIG. 1, skipping the second video frame F2 will make the falling ball seem to appear suddenly on the ground, and the movement of the ball becomes a puzzling and absurd visual experience for viewers. To be more specific, when the video bitstream contains human vision sensitive elements, such as fast-motion objects or rapidly varying brightness, the conventional AV synchronization techniques, like dropping or repeating video frames, may lead to unpleasant visual experiences.

Therefore, it is desired to provide an audio-video (AV) synchronization method and an audio-video synchronization module to solve the aforementioned problems.

### SUMMARY

According to a first aspect of the present invention, an exemplary audio-video synchronization method is provided for synchronizing playback of a video bitstream and playback of an audio bitstream. The video bitstream includes a plurality of video frames. The exemplary audio-video synchronization method includes: deriving an indication information and a timing information corresponding to a video current frame from the video bitstream, wherein the indication information is indicative of motion magnitude of the current video frame; and referring to the indication information, the timing information and a system clock to deal with the current video frame for synchronizing playback of the video bitstream and playback of the audio bitstream.

According to a second aspect of the present invention, an exemplary audio-video synchronization method is provided for synchronizing playback of a video bitstream and playback of an audio bitstream. The video bitstream includes a plurality of video frames. The exemplary audio-video synchronization method includes: deriving an indication information and a timing information corresponding to a video current frame from the video bitstream, wherein the indication information is a decoded information of the current video frame; and referring to the indication information, the timing information and a system clock to deal with the current video frame for synchronizing playback of the video bitstream and playback of the audio bitstream.

According to a third aspect of the present invention, an exemplary audio-video synchronization module is provided for synchronizing playback of a video bitstream and playback of an audio bitstream. The video bitstream includes a plurality of video frames. The exemplary audio-video synchronization module includes a detection unit and a processing unit. The detection unit is for deriving an indication information and a timing information corresponding to a video current frame from the video bitstream, wherein the indication information is indicative of motion magnitude of the current video frame. The processing unit is for receiving the indication information and referring to the indication information, the timing information and a system clock to deal with the current video frame for synchronizing playback of the video bitstream and playback of the audio bitstream.

According to a fourth aspect of the present invention, an exemplary audio-video synchronization module is provided for synchronizing playback of a video bitstream and playback of an audio bitstream. The video bitstream includes a plurality of video frames. The exemplary audio-video synchronization module includes a detection unit and a processing unit. The detection unit is for deriving an indication information and a timing information corresponding to a video current frame from the video bitstream, wherein the indication information is a decoded information of the current video frame. The processing unit is for receiving the indication information and referring to the indication information, the timing information and a system clock to deal with the current video frame for synchronizing playback of the video bitstream and playback of the audio bitstream.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional AV synchronization method.

FIG. 2 is a block diagram of an exemplary multimedia processing system according to an embodiment of the present invention.

FIG. 3 is a diagram illustrating an exemplary AV synchronization performed by an AV synchronization module for video frames according to an embodiment of the present invention.

FIG. 4 is a diagram illustrating an exemplary AV synchronization performed by an AV synchronization module for video frames according to another embodiment of the present invention.

FIG. 5 is a block diagram of an exemplary multimedia processing system according to another embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

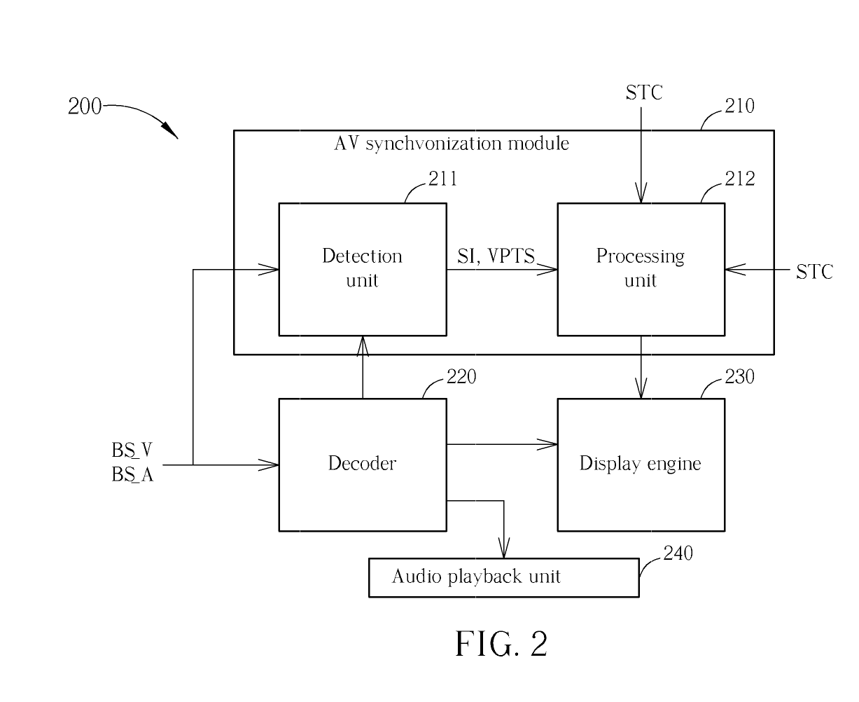

Please refer to FIG. 2, which is a block diagram of an exemplary multimedia processing system 200 according to an embodiment of the present invention. The multimedia processing system 200 includes (but not limited to) an audio-video (AV) synchronization module 210, a decoder 220, a display engine 230 and an audio playback unit 240. The AV synchronization module 210 synchronizes playback of an audio bitstream BS_A and playback of a video bitstream BS_V including a plurality of video frames. The AV synchronization module 210 includes (but not limited to) a detection unit 211 and a processing unit 212. The decoder 220 may include an audio decoding circuit (not shown) for decoding the incoming audio bitstream BS_A and a video decoding circuit (not shown) for decoding the incoming video bitstream BS_V. The display engine 230 is arranged for driving a video output device (e.g., a display screen) to display decoded video frames, which are derived from processing the video bitstream BS_V, according to a decision output from the AV synchronization module 210, and the audio playback unit 240 is arranged for driving an audio output device (e.g., a speaker) for playing decoded audio samples derived from processing the audio bitstream BS_A. In this exemplary embodiment, with the decision output from the AV synchronization module 210, the display engine 230 may selectively repeat the current video frame for AV synchronization, drop the current video frame for AV synchronization, or just normally display the current video frame.

The detection unit 211 is arranged for processing the video bitstream BS_V to derive an indication information SI and a timing information VPTS corresponding to a current video frame (e.g., a video presentation time stamp), wherein the indication information SI is indicative of motion magnitude of the current video frame. For example, the indication information SI may be derived from processing a decoded result of the video bitstream BS_V. Each of a decoded current video frame and a decoded previous video frame is a complete picture, and the detection unit 211 compares the decoded current video frame and the decoded previous video frame to identify the motion magnitude associated with the current video frame, and generates the indication information SI for the current video frame correspondingly. In an alternative design, the indication information SI may be derived from a content-related information of the video bitstream BS_V, which is obtained during decoding the current video frame included in the video bitstream BS_V of the decoder 220. To be more specific, the video decoding circuit in the decoder 220 would identify the aforementioned content-related information (e.g., motion vectors of the current video frame) when decoding the current video frame. A parameter may be calculated from motion vectors of the current video frame, and then referenced by the detection unit 211 for determining the indication information SI for the current video frame. By way of example, but not limitation, when the video bitstream BS_V is transmitting fast-motion video frames, motion vectors with large magnitude are detected and so is the indication information SI.

In yet another alternative design, the indication information SI may be derived from a header of the current video frame, which will give a rough but quick result. For example, the indication information SI is a frame type which indicates whether the current video frame is an intra-coded frame (e.g., an I frame) or an inter-coded frame (e.g., a P frame or B frame). Please note that the frame type may be indicative of the motion magnitude. An intra-coded frame (i.e., an I frame) implies that the decoding of the current video frame is irrelevant to a previous or a next frame. A predicted frame (i.e., a P frame) is related to a previous frame, and therefore may imply that a fast-motion content is involved in the current video frame. A bi-directional frame (i.e., a B frame) is related to a plurality of frames including a previous frame and a following frame, and therefore may imply that there is a huge amount of motion contents within the current video frame. However, these are not supposed to be limitations to the present invention. For example, the indication information SI may be configured by any parameter capable of indicating the motion magnitude of the current video frame , such as the motion information of the current video frame, a luminance variation information of the current video frame, a frame type of the current video frame or a combination of the aforementioned information. These all obey the spirit of the present invention, and fall within the scope of the present invention.

The processing unit 212 is coupled to the detection unit 211, and is implemented for receiving the indication information SI and referring to the indication information SI, the timing information (e.g. VPTS) and a system time clock STC to deal with the current video frame for controlling the AV synchronization of playback of the video bitstream and playback of the audio bitstream. As a person skilled in the art can readily understand how to generate the system time clock STC used in a decoder side according to program clock reference (PCR) transmitted via the transport stream, further description is omitted here for brevity. When the indication information SI indicates that the motion magnitude of the current video frame is lower than a threshold, the processing unit 212 operates as a conventional synchronization apparatus to determine to drop or repeat the current video frame when there exists a difference between the system time clock STC and the timing information VPTS. In this case, the playback of the video and audio signals has only a minor difference and has no major impact upon visual perception of the viewer, and the conventional synchronization technique is sufficient to eliminate the minor difference efficiently; otherwise, the current video frame will be displayed normally. However, when the indication information SI indicates that the motion magnitude of the current video frame exceeds the threshold, the processing unit 212 will work differently. For example, the processing unit 212 stops an operation of the AV synchronization for allowing the current video frame to be displayed normally via the display engine 230. In addition, the operation of the AV synchronization is temporarily stopped, and when the motion magnitude of the current video frame declines below the threshold, the processing unit 212 may further determines to resume the operation of the AV synchronization.

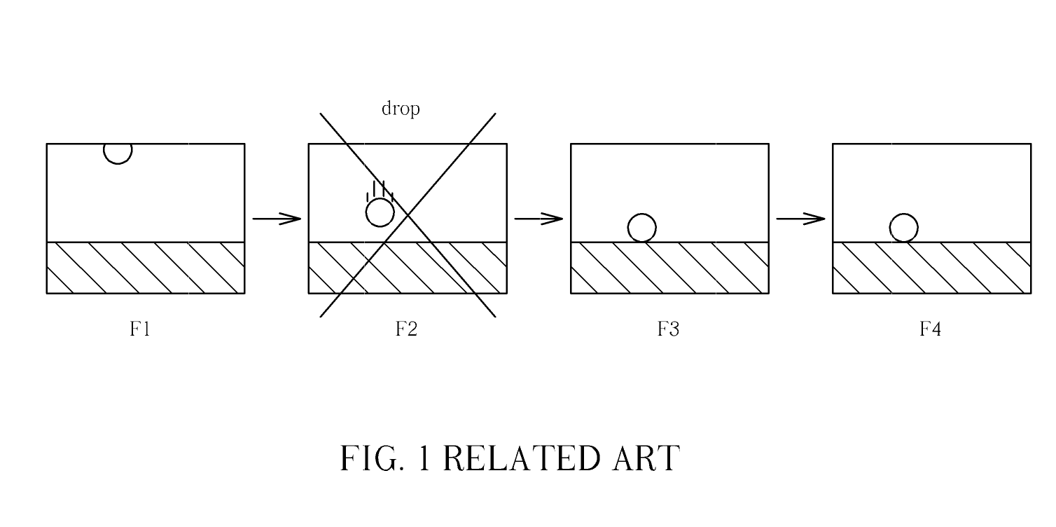

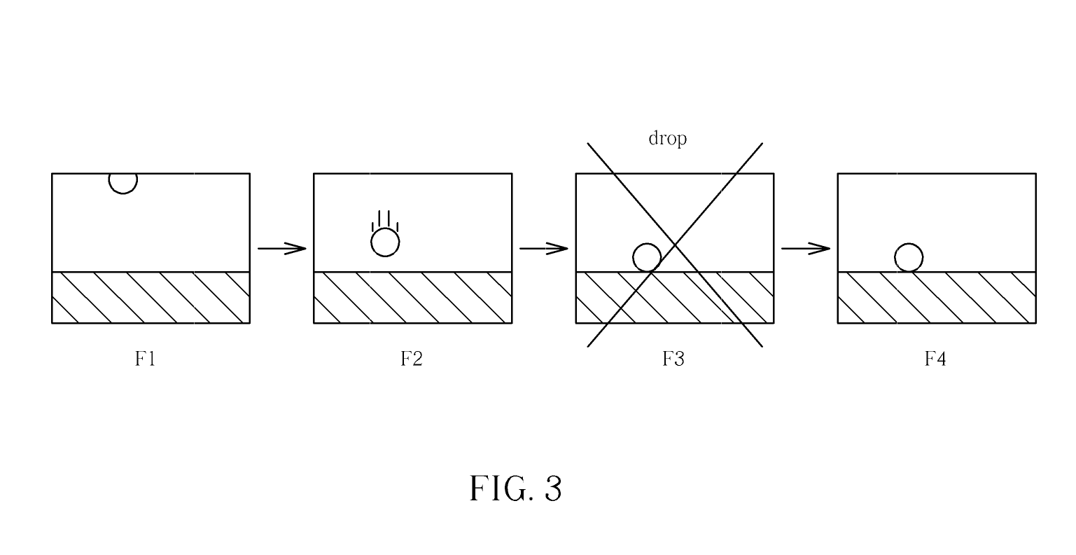

Please refer to FIG. 3, which is a diagram illustrating an exemplary AV synchronization performed by the AV synchronization module 210 for video frames F1-F4 according to an embodiment of the present invention. Consider a similar AV synchronization scenario as shown in FIG. 1. When a synchronization error is detected during processing of the second video frame F2, which implies a desired skipping of the second video frame F2 for AV synchronization in conventional AV synchronization method, the corresponding indication information SI also indicates a large motion magnitude in the second video frame F2; therefore, the processing unit 212 will not drop the second video frame F2 but display it normally. Next, when the decoder 220 processes the third video frame F3, and the corresponding indication information SI indicates that the motion magnitude declines below the threshold, the processing unit 212 will carry on AV synchronization and drop the third video frame F3. As shown in FIG. 3, the third video frame F3 is a still scene. Thus, skipping the third video frame F3 would be more natural to human eyes than skipping the second video frame F2. In this way, the user may have an experience of a smoother and more enjoyable audio and video playback.

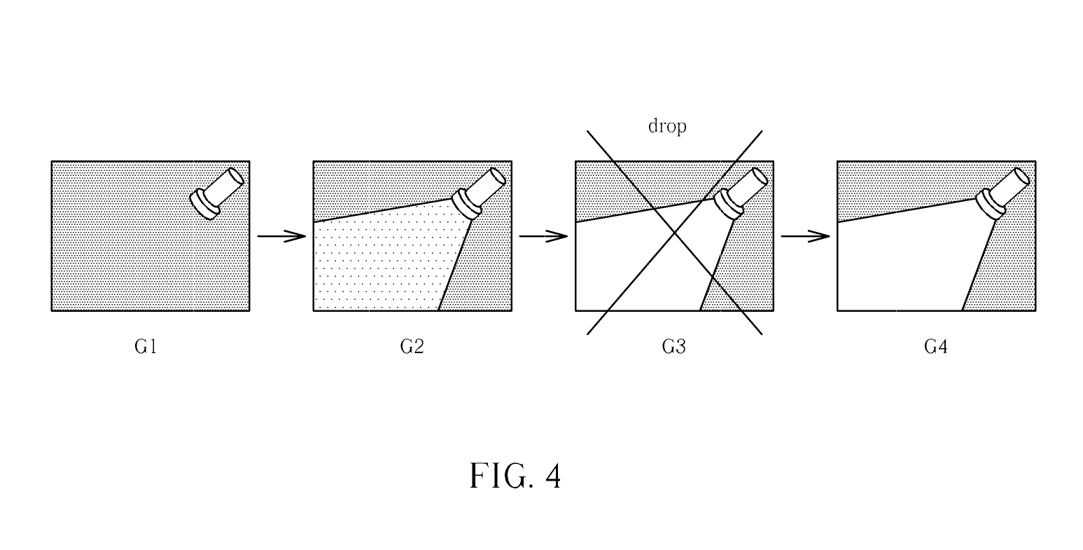

As mentioned previously, the indication information SI of the present invention is not limited to motion information. That is, the indication information SI may be another parameter indicative of the motion magnitude, such as a luminance variation information of the current video frame. Please refer to FIG. 4, which is a diagram illustrating an exemplary AV synchronization performed by the AV synchronization module 210 for video frames G1-G4 according to another embodiment of the present invention. The sequential video frames G1-G4 demonstrate a flashlight being gradually turned on from an off state in a dark environment. In this case, the detection unit 211 will derive the indication information SI which records the luminance variation of the current video frame to indicate the motion magnitude. When a synchronization error is detected at the video frame G2, the processing unit 212 will not determine to drop the video frame G2 immediately, but choose to drop the next video frame G3 since the luminance variation of dropping the next video frame G3 would be far less intense than dropping the video frame G2.

Although the AV synchronization module 210 is capable of providing video/audio playback more suitable for the user by delaying a timing of AV synchronization, the AV synchronization should not be postponed for a predetermined number of frames; otherwise, the presented asynchronous video/audio playback would be more intolerable. Therefore, when an asynchronous degree, i.e., the difference between the system time clock STC and the timing information VPTS, is larger than a predetermined time threshold (or a time of a predetermined number of frames), the processing unit 212 will still determine to perform synchronization regardless of the indication information SI.

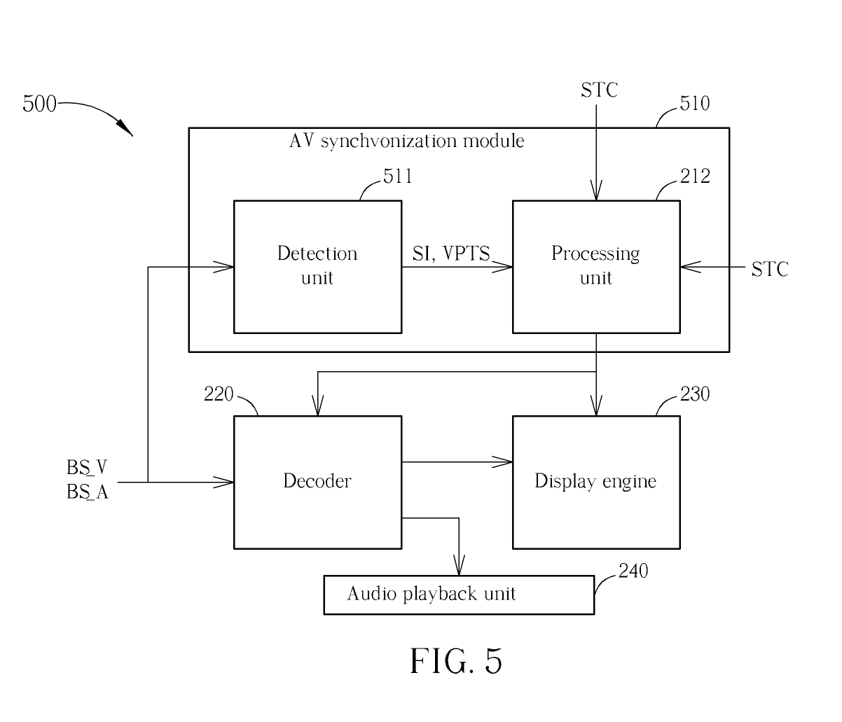

Please refer to FIG. 5, which is a block diagram of an exemplary multimedia processing system 500 according to another embodiment of the present invention. The multimedia processing system 500 includes (but not limited to) an AV synchronization module 510, the decoder 220, the display engine 230 and the audio playback unit 240. As the processing unit 212, the decoder 220, the display engine 230 and the audio playback unit 240 are substantially identical to their counterparts shown in FIG. 2, further description is omitted here for brevity. The AV synchronization module 510 includes (but not limited to) a detection unit 511 and the processing unit 212. In FIG. 2, the detection unit 211 may rely on the information provided by the decoder 220 to derive the indication information SI, whereas the detection unit 511 in FIG. 5 is allowed to process the incoming video bitstream BS_V and derive the indication information SI internally. Since only a small portion of decoded data, such as the frame type information in the header or the frame motion information, is required, more processing time can be saved by using the detection unit 511. Besides, when the processing unit 212 determines that the current video frame is to be dropped, the processing unit 212 can inform the decoder 220 to skip processing the dropped video frame to save more system resource.

In summary, by detecting certain motion magnitude information, AV synchronization actions such as repeating or dropping a video frame with large motion magnitude can be avoided. Therefore, the exemplary audio-video synchronization method and the exemplary audio-video synchronization apparatus of the present invention are capable of providing audio/video playback more natural to human sense.

Those skilled in the art will readily observe that numerous modifications and alterations of the device and method may be made while retaining the teachings of the invention.

What is claimed is:

1. An audio-video synchronization method, for synchronizing playback of a video bitstream and playback of an audio bitstream, the video bitstream comprising a plurality of video frames, the audio-video synchronization method comprising:
deriving an indication information and a timing information corresponding to a current video frame from the video bitstream, wherein the indication information is indicative of motion magnitude of the current video frame; and
referring to the indication information, the timing information and a system clock to deal with the current video frame for synchronizing playback of the video bitstream and playback of the audio bitstream.

2. The audio-video synchronization method of claim 1, wherein the indication information includes at least one of a motion information of the current video frame, a luminance variation information of the current video frame, and a frame type of the current video frame.

3. The audio-video synchronization method of claim 1, wherein the indication information is derived from decoding the current video frame.

4. The audio-video synchronization method of claim 1, wherein the indication information is derived from a decoding result of the video bitstream.

5. The audio-video synchronization method of claim 1, wherein the indication information is derived from a header of the current video frame.

6. The audio-video synchronization method of claim 1, wherein the step of referring to the indication information, the timing information and the system clock to deal with the current video frame comprises:
when the indication information indicates that the motion magnitude of the current video frame exceeds a threshold, stopping an operation of AV synchronization.

7. The audio-video synchronization method of claim 6, wherein the step of referring to the indication information, the timing information and the system clock to deal with the current video frame comprises:
when the indication information indicates that the motion magnitude of the current video frame declines below the threshold, resuming the operation of AV synchronization.

8. An audio-video synchronization method, for synchronizing playback of a video bitstream and playback of an audio bitstream, the video bitstream comprising a plurality of video frames, the audio-video synchronization method comprising:
deriving an indication information and a timing information corresponding to a current video frame from the video bitstream, wherein the indication information is a decoded information of the current video frame; and
referring to the indication information, the timing information and a system clock to deal with the current video frame for synchronizing playback of the video bitstream and playback of the audio bitstream.

9. The audio-video synchronization method of claim 8, wherein the step of referring to the indication information, the timing information and the system clock to deal with the current video frame comprises:
when the indication information indicates that the motion magnitude of the current video frame exceeds a threshold, stopping an operation of AV synchronization.

10. The audio-video synchronization method of claim 9, wherein the step of referring to the indication information, the timing information and the system clock to deal with the current video frame comprises:
when the indication information indicates that the motion magnitude of the current video frame declines below the threshold, resuming the operation of AV synchronization.

11. An audio-video synchronization module, for synchronizing playback of a video bitstream and playback of an audio bitstream, the video bitstream comprising a plurality of video frames, the audio-video synchronization module comprising:
a detection unit, for deriving an indication information and a timing information corresponding to a video current frame from the video bitstream, wherein the indication information is indicative of motion magnitude of the current video frame; and
a processing unit, coupled to the detection unit, for receiving the indication information and referring to the indication information, the timing information and a system clock to deal with the current video frame for synchronizing playback of the video bitstream and playback of the audio bitstream.

12. The audio-video synchronization module of claim 11, wherein the indication information includes at least one of a motion information of the current video frame, a luminance variation information of the current video frame, and a frame type of the current video frame.

13. The audio-video synchronization module of claim 11, wherein the indication information is derived from decoding the current video frame.

14. The audio-video synchronization module of claim 11, wherein the indication information is derived from a decoding result of the video bitstream.

15. The audio-video synchronization module of claim 11, wherein the indication information is derived from a header of the current video frame.

16. The audio-video synchronization module of claim 11, wherein when the indication information indicates that the motion magnitude of the current video frame exceeds a threshold, the processing unit determines to stop an operation of AV synchronization.

17. The audio-video synchronization module of claim 16, wherein when the indication information indicates that the motion magnitude of the current video frame declines below the threshold, the processing unit determines to resume the operation of AV synchronization.

18. An audio-video synchronization module, for synchronizing playback of a video bitstream and playback of an audio bitstream, the video bitstream comprising a plurality of video frames, the audio-video synchronization module comprising:
a detection unit, for deriving an indication information and a timing information corresponding to a current video frame from the video bitstream, wherein the indication information is a decoded information of the current video frame; and
a processing unit, coupled to the detection unit, for receiving the indication information and referring to the indication information, the timing information and a system clock to deal with the current video frame for synchronizing playback of the video bitstream and playback of the audio bitstream.

19. The audio-video synchronization module of claim 18, wherein when the indication information indicates that the motion magnitude of the current video frame exceeds a threshold, the processing unit determines to stop an operation of AV synchronization.

20. The audio-video synchronization module of claim 18, wherein when the indication information indicates that the motion magnitude of the current video frame declines below the threshold, the processing unit determines to resume the operation of AV synchronization.
